(19) United States
(12) Patent Application Publication
(10) Pub. No.: US 2026/0001497 A1
(43) Pub. Date: Jan. 1, 2026

(54) SEPARATION TOILET FOR A VEHICLE

(71) Applicant: Siemens Mobility GmbH, München (DE)

(72) Inventor: Stefan Wanczura, Recklinghausen (DE)

(21) Appl. No.: 18/879,906

(22) PCT Filed: May 31, 2023
(86) PCT No.: PCT/EP2023/064507

§ 371 Date: Dec. 30, 2024

(30) Foreign Application Priority Data
Jun. 30, 2022 (DE) 10 2022 206 699.5

(51) Int. Cl. B60R 15/04

(52) U.S. Cl. CPC B60R 15/04

(57) ABSTRACT

A separation toilet for a vehicle has a toilet bowl and separate discharge lines for feces and urine. The discharge line for feces is arranged at the lowest point of the toilet bowl. The toilet bowl has an upper and a lower part. The lower part is at least partially enclosed by the upper part, and an opening for discharging the urine extends all the way around between the upper and lower part.

The invention relates to a separation toilet with a toilet bowl and separate discharge lines for feces and urine, wherein the discharge line for feces is arranged at the lowest point in the toilet bowl, and also to a vehicle with a separation toilet.

So-called separation toilets or no-mix toilets are already known from WO 92/19824 A1. In said patent separate bowls are provided for collecting urine and other feces. JP 4 051404 B teaches a slit arranged in a toilet bowl for collecting the urine.

A further separation toilet is shown in WO 2014/022873 A2. Further details on this separation toilet (NoMix Toilet) can be retrieved from https://www.urinetrap.com/at the time of this application. By utilizing the surface tension, urine is discharged into a separate outlet—the urine trap—and is separated in this way from the rest, in particular from feces or other solids. The outflow of urine takes place under the force of gravity via the urine trap, while flush water passes in large part into the sanitation system, since, due to the specific shape of the toilet and due to the pressure with which it is emitted into the toilet, it overshoots the urine trap.

The arrangements described of the two outlet openings for liquid and solid excretions necessarily produce restrictions in respect of the effectiveness of the urine separation for its sitting and standing function. There are also restrictions in respect of the differences in female and male anatomy.

The underlying object of the invention is to specify a separation toilet with more effective separation of urine and solid excretions.

The object is achieved by the subject matter of independent claim 1. Developments and embodiments of the invention can be found in the features of the dependent claims.

An inventive separation toilet comprises a toilet bowl and separate discharge lines for feces and urine, wherein the discharge line for feces is arranged at the lowest point of the toilet bowl and wherein the toilet bowl has an upper and a lower part, wherein the lower part is enclosed at least partly by the upper part and an opening extending all the way around for discharge of urine is arranged between the upper and lower part.

The toilet bowl is embodied to be suitable both for standing and also for sitting use and can also be referred to as a commode. It is formed in a bowl-shape with an inner wall for collecting and discharging excretions. The inner wall is provided with an opening extending all the way around for the discharge of the urine. The opening extending all the way around can also be referred to as a circumferential urine trap. It can be embodied relatively narrow; the distance between the inner wall of the upper part to the inner wall and the lower part is thus relatively small.

The inner wall of the upper part of the toilet bowl is guided in a lower section continuously at least partly to behind the lower part of the toilet bowl and thus encloses said part, in particular encloses the circumference of an upper section of the lower part of the toilet bowl at least partly. The upper section of the lower part of the toilet bowl thus projects somewhat into the upper part of the toilet bowl and in the area of the overlap the upper part encloses the lower part.

The opening extending all the way around runs through 360° of the inner wall of the toilet bowl. In particular it runs in an essentially horizontal plane over the entire inner wall. This plane, which is spanned by the opening extending all the way around in the toilet bowl, can also be slightly inclined. In accordance with one development, the opening extending all the way around for discharge of the urine is arranged between upper and lower part in the lower third of the toilet bowl.

Through the urine trap extending all the way around, the stream of urine is conveyed independently of its point of contact onto the inner wall of the upper part of the toilet bowl by friction forces, laminarly along the inner wall of the upper part of the toilet bowl and directed into the opening extending all the way around. From there the urine collected in this way can be discharged by means of a discharge line for urine separate from the discharge line for feces.

Only the stream of urine that strikes the discharge line for feces, in particular in the middle, at the lowest point of the toilet bowl centrally or below the urine trap extending all the way around on the lower part of the toilet bowl cannot be separated and is therefore discharged as well via the discharge line for the feces.

In accordance with a further development of the invention, the upper part of the toilet bowl has a widened section extending all the way around in the area of the opening of the toilet bowl extending all the way around, wherein the upper part encloses the lower part of the toilet bowl in the area of the widened section extending all the way around. The widened section extending all the way around is thus arranged in the lower section of the upper part of the toilet bowl. Thus the upper section of the lower part of the toilet bowl can project into the upper part of the toilet bowl, whereby it is enclosed all the way around by the upper part, free from a projection of the lower part to the upper part or free from an offset to the inside in the inner wall of the toilet bowl from the upper toward the lower part in the area of the opening extending all the way around. The relatively narrow opening extending all the way around could thus also be seen as a slit by a user.

Urine striking the upper part of the toilet bowl is discharged, driven by the force of gravity, utilizing its surface tension, over the upper part of the toilet bowl into the opening extending all the way around. To this end the widened section of the upper part of the toilet bowl extending all the way around can be embodied in accordance with a further development with a constant round course, which is dimensioned so that urine or other liquids of a predetermined density and surface tension striking the upper part of the toilet bowl and running down it are discharged, driven by the force of gravity, utilizing the surface tension over the rounded part of the widened section extending all the way around into the opening extending all the way around. The rounded part could be referred to a rounded discharge part, the widened section also as a bulge. Through the rounded part the discharged urine is conveyed behind the overlap between the upper and the lower part of the toilet bowl, collected there where necessary and is thus able to be discharged separately from the feces. The opening extending all the way around could also be referred to as an inlet opening.

In accordance with a further development, the toilet bowl has a return of its inner wall from the upper part toward the lower part in the area of the opening extending all the way around. Through this return between the upper and lower part of the toilet bowl in the area of the opening extending all the way around, this is optically covered by the upper part and can barely be seen from above by a user and moreover is well protected from possible contamination by feces.

In accordance with a further development, the toilet bowl has a collecting channel for urine extending all the way around, which is arranged below the opening extending all the way around. The collecting channel is thus arranged between the lower section of the upper part of the toilet bowl enclosing the lower part and the upper section of the lower part of the toilet bowl and thus outside of the inner wall of the toilet bowl. Through the urine trap extending all the way around the stream of urine is conveyed, independently of the point at which its strikes the inner wall of the upper part of the toilet bowl, by friction forces, laminarly along the inner wall of the upper part of the toilet bowl and over the rounded discharge part into the collecting channel of the urine trap and is collected there.

In a development, a urine discharge line can be arranged at the lowest point of the collecting channel, in order to discharge the urine collected there.

In accordance with an advantageous form of embodiment, the upper part of the toilet bowl can open out into the collecting channel or merge into it.

In a development, the upper and lower part of the toilet bowl are embodied as two separately produced shells. These are especially joined together to form the toilet bowl. In a development, the upper and lower part of the toilet bowl are connected to one another in the area of the collecting channel, especially with a material-to-material connection to one another. If the upper and the lower part of the toilet bowl comprise a metal or a metal alloy, as in a further development of the invention, or if they are made especially of metal or of a metal alloy, especially of stainless steel or consist predominantly of a metal or of a metal alloy, then they can be welded to one another for example, for example in the area of the collecting channel, connected with a weld seam all the way around.

In a simple way the upper and lower part of the toilet bowl are manufactured as a pressed metal or deep-drawn part.

Thus the toilet bowl can be integrated relatively easily into the overall system of a vacuum toilet, which consists of further components arranged around the toilet bowl. As an alternative, the toilet bowl can also be manufactured from other materials, such as sanitary ceramics for example.

In accordance with a further development of the invention, the separation toilet is embodied as a vacuum toilet and is then in particular equipped accordingly.

In accordance with a further development, the lower part of the toilet bowl, in particular the upper section of the lower part of the toilet bowl, has a fold in the area of the opening extending all the way around.

The wall of the lower part is folded over and thus has a wall pointing inward, into the toilet bowl—the inner wall—and also, on the other side of the fold, a wall pointing outward, which for example opens out into the collecting channel of merges into said channel. The wall is thus continuous and can run continuously.

The principle of urine separation in accordance with the invention with a urine trap extending all the way around functions both in the sitting and also in the standing position of the user of the separation toilet. Contamination of the urine with the feces is thus excluded effectively and as well as possible. The separation in this case is passive, i.e. without additional, in particular moving, parts and without additional energy. The basic principle is able to be adapted for various designs. Thus, also accordingly as a vacuum toilet, since the toilet bowl is able to be well integrated into existing vacuum toilet systems with water flushing. A lower water consumption compared to normal NoMix flushing toilets is also able to be achieved through this. Instead of a relatively large wastewater tank, two smaller urine and feces tanks are now provided or a combined urine and feces tank with two separate chambers, which can be embodied smaller than a conventional wastewater tank as regards installation space. The installation space disadvantages of the toilet bowl compared with known vacuum toilets with water flushing on the other hand are insignificant. Associated with this are also savings in weight, in particular for use in vehicles. The separately collected urine is also able to be used as a resource, for fertilizer production for example.

In accordance with a further development of the invention, the separation toilet comprises an apparatus for processing of urine, which is arranged between the discharge line for urine and a urine tank.

Further developed, the apparatus for processing of urine has at least one electrolysis cell for electrochemical precipitation of struvite, in particular comprising at least one anode comprising magnesium.

Through the processing of the urine, which in particular makes possible a struvite precipitation in an electrochemical way, urine scale in the line system of the apparatus is avoided. No additional chemicals are required for struvite precipitation, since the processing functions by means of electrolysis independently of the pH value of the urine. At the same time germs in the urine are killed and recontamination is slowed down. The apparatus for processing of urine between the discharge line for urine and the urine tank, in particular between the at least one shut-off element and the urine tank, acts as an integrated intermediate urine tank, which will obviate the need for an additional intermediate tank and brings about further installation space benefits. Precipitated struvite can be drawn off separately and further processed. Separated urine in the urine tank can be employed as a resource, in particular for fertilizer production. The struvite obtained is odor-free, free from medicine residues and heavy metals and can therefore likewise be used as fertilizer. What is involved overall is a recovery of raw material via struvite precipitation in the sense of recycling. Separately discharged and collected feces can likewise be treated in a bioreactor, which additionally increases waste disposal intervals (example of a bioreactor made by Protec (http://www.akwauvprotec.com). As an alternative they can be further processed into compost, or made use of thermally.

An inventive vehicle, in particular an air, water or land vehicle, for example a rail vehicle, in particular for public transport, comprises at least one inventive separation toilet.

The invention allows numerous forms of embodiment. They will be explained below in greater detail with the aid of the figures in which an exemplary embodiment is shown in each case. The same elements in the figures are provided with the same reference characters.

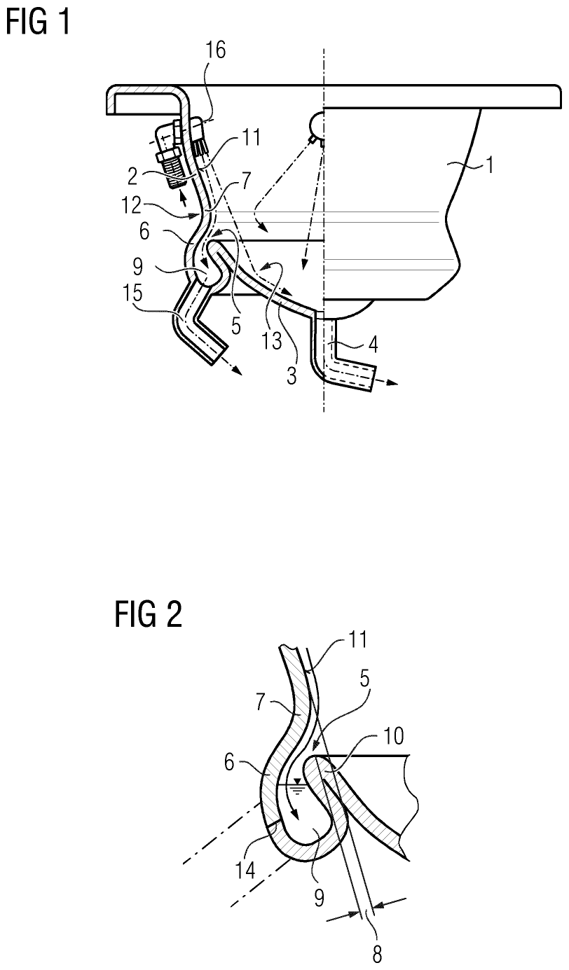

FIG. 1 shows schematically an inventive separation toilet in a part section,

FIG. 2 shows a detailed section of the separation toilet from FIG. 1,

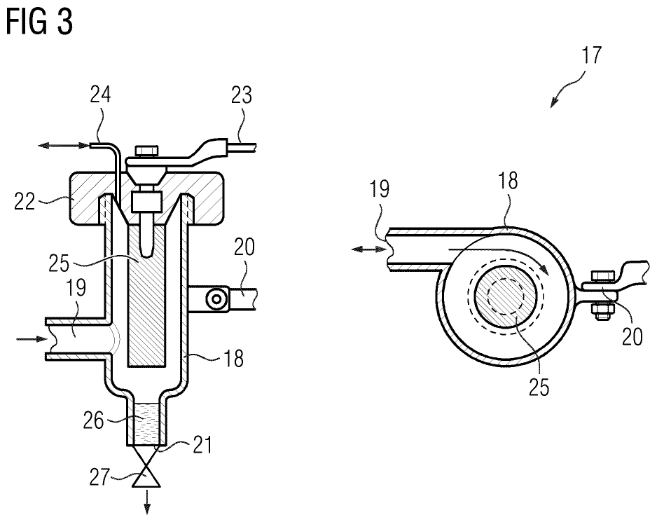

FIG. 3 shows an exemplary embodiment of a processing apparatus for urine.

Shown in a part section in FIG. 1 is an inventive separation toilet. In FIG. 2, a section of this separation toilet is illustrated in greater detail, which is why both figures will be described together below.

The separation toilet comprises a toilet bowl 1 with separate discharge lines for feces 4 and urine 15, wherein the discharge line for feces 4 is arranged at the lowest point of the toilet bowl 1.

The toilet bowl 1 comprises an upper part 2 and a lower part 3. Both the upper and also the lower part 2 and 3 are manufactured here as two shells made of a metal or a metal alloy, produced separately for example as a pressed metal or deep-drawn part and welded to one another. The upper part 2 has the form of a positively curved shell open on both sides.

In a lower section 12 of the upper part 2 said part has a widened section 6 extending all the way around open to the bottom. Through this a diameter of the upper part 2 in the lower section 12 is greater than the diameter of an upper section 13 of the lower part 3. The lower part 3 is enclosed completely in its upper section 13 by the upper part 2 in the area of its lower section 12.

The upper part 2 and lower part 3 of the toilet bowl 1 together form the inner wall 11 of the toilet bowl 1 and thus delimit a space for collection of excretions.

For discharge of urine striking the upper part 2, an opening 5 extending all the way around for discharge of the urine is arranged between the upper part 2 and lower part 3. The opening 5 extending all the way around thus extends over 360° of the entire diameter of the toilet bowl 1, in particular in a lower third of the toilet bowl 1.

Independently of where it strikes the inner wall 11 of the upper part 2 of the toilet bowl 1, urine is conveyed by friction forces, laminarly along the inner wall 11 of the upper part 2 of the toilet bowl 1 and directed into the opening 5 extending all the way around. To this end the widened section 6 of the upper part 2 extending all the way around has rounded section 7a running constantly, which is shaped so that urine striking the upper part 2 of the toilet bowl 1 and running down is discharged driven by the force of gravity using its surface tension via the rounded section 7 of the widened section 6 into the opening 5 extending all the way around.

The urine is thus conveyed along the inner wall 11 of the upper part 2 of the toilet bowl into the space between the upper part 2 and the lower part 3, in which the upper part 2 encloses the lower part 3. It is collected there by means of a collecting channel 9 likewise extending all the way around and collected at the lowest point of the collecting channel 9 by a discharge line 15 arranged there for collected urine.

The collecting channel 9 is formed here by a collar or lip formed on the lower part 3 on or from said part. First of all the lower part 3 here has a fold 10 in the upper section 13. Located adjoining this is the depression, which forms the collecting channel 9, so that the lower part 2 has a continuous wall from the inside of the toilet bowl 1 over the fold 10 to the collecting channel 9. Conversely the upper part 2 also has a continuous wall from the inside of the toilet bowl 1 over the rounded section 7 of the widened section 6 extending all the way around to behind the enclosed upper section 13 of the lower part 3, which opens out into the collecting channel 9 extending all the way around. A weld seam 14, along which the upper part 2 is connected with a material-to-material connection to the lower part 3, is located in this exemplary embodiment in the area of the collecting channel 9. In the area of the collecting channel 9 there thus exists an overlap between the upper and the lower part 2 and 3 of the toilet bowl 1.

In the area of the opening 5 extending all the way around, the inner wall 11 of the toilet bowl 1 has a relatively small return 8. Through this offset between the upper and lower shell, in the area of the opening 5 extending all the way around, this is visually barely able to be perceived from above and moreover is well protected against any possible contamination by feces.

In order to fill and to seal the feces and urine discharge line 4 and 15 with a minimal amount of water in an odor-proof manner, a flushing nozzle 16 can be arranged within the toilet bowl 1, which is correspondingly suitably embodied and aligned.

A processing apparatus for urine can be connected to the urine discharge line 15.

FIG. 3 now shows an exemplary embodiment of a processing apparatus 17 for urine in a cross-section and a longitudinal section.

The processing apparatus 17 has a housing 18 with a urine-inlet 19 and an electrical connection 20. The urine inlet 19 of the processing apparatus 17 is connected to the urine discharge line 15 of the toilet bowl 1 and thus is also connected to the discharge line 5 for urine in terms of flow, and accepts the urine collected in the toilet bowl 1 and discharged from said bowl. The processing apparatus 17 thus also acts as a type of intermediate tank. What is more, the housing 18 has an outlet 21, which is connected, where necessary via a further shut-off valve 27, to a neighboring urine tank. The outlet 21 is arranged at the lowest point of the housing 18. Via said outlet struvite precipitations 26, collect, which can be discharged through the outlet 21.

Opposite the outlet 21 is screw cover 22 with a further electrical connection 23 and with a pressure line 24 for the supply of compressed air into the housing 18, in order to empty the housing for example, or to generate a vacuum in the housing 18, in order to draw out urine for example. Connected to the screw cover 22 is a sacrificial anode 25, which projects into the reactor space of the housing 18. The sacrificial anode 25, in particular a magnesium bar, is connected electrically to the electrical connection 23 of the screw cover 22. This in its turn is connected to the plus pole of a direct current source. The magnesium bar is a wear part and must be renewed at periodic intervals. The housing 18 of the processing apparatus 17 itself is connected to the minus pole of the direct current source and serves as the cathode.

Urine is drawn into the processing apparatus 17 by a part vacuum and a struvite precipitation from the urine is undertaken by electrochemical means. In this case any germs that may be present are largely killed by the electrolysis at the same time. Struvite collects on the floor of the processing apparatus 17 and is conveyed onward into the urine tank in the next process step by means of overpressure. In the urine tank the struvite precipitations are not a problem because they do not dry out there and collect on the floor of the container.

1-14. (canceled)

15. A separation toilet, comprising:
a toilet bowl having an upper part and a lower part, wherein said lower part is enclosed at least partly by said upper part and disposed between said upper part and said lower part is an opening extending all a way around for a discharge of urine; and
separate discharge lines including a discharge line for feces and a discharge line for the urine, wherein said discharge line for feces is disposed at a lowest point of said toilet bowl.

16. The separation toilet according to claim 15, wherein said opening extending all the way around is disposed between said upper part and said lower part in a lower third of said toilet bowl.

17. The separation toilet according to claim 15, wherein said upper part of said toilet bowl has a widened section extending all a way around in an area of said opening extending all the way around, wherein said upper part encloses said lower part in said area of said widened section extending all the way around.

18. The separation toilet according to claim 17, wherein said widened section of said upper part of said toilet bowl extending all the way around is shaped with a continuously running rounded section, which is embodied so that the urine striking said upper part of said toilet bowl and running down said toilet bowl, is discharged, driven by gravity, utilizing surface tension into said opening extending all the way around.

19. The separation toilet according to claim 17, wherein said toilet bowl has an inner wall with a return running from said upper part through to said lower part in said area of said opening extending all the way around.

20. The separation toilet according to claim 15, further comprising a collection channel for the urine extending all the way around, which is disposed below said opening extending all the way around.

21. The separation toilet according to claim 15, wherein said upper part and said lower part of said toilet bowl are embodied as two separately produced shells.

22. The separation toilet according to claim 20, wherein said upper part and said lower part of said toilet bowl are connected to one another in an area of said collection channel.

23. The separation toilet according to claim 15, wherein said lower part of said toilet bowl has a fold extending all a way around in an area of said opening extending all the way around.

24. The separation toilet according to claim 15, wherein at least said upper part and said lower part of said toilet bowl contain metal or a metal alloy.

25. The separation toilet according to claim 15, wherein said separation toilet is embodied as a vacuum toilet.

26. The separation toilet according to claim 15, further comprising:
a urine tank; and
an apparatus for processing of the urine, said apparatus is disposed between said opening extending all the way around for discharge of the urine and said urine tank.

27. The separation toilet according to claim 26, wherein said apparatus for processing of the urine has at least one electrolysis cell for electrochemical precipitation of struvite.

28. A vehicle, comprising:
at least one said separation toilet according to claim 15.
